(19) United States
(12) Patent Application Publication
(10) Pub. No.: US 2006/0180623 A1
(43) Pub. Date: Aug. 17, 2006

(54) Rear vehicle storage system

(76) Inventors: Brian J. Reynolds, Oxford, MI (US); Bruce Higgins, South Lyon, MI (US); Stephen Hawkins, Ypsilanti, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/056,985

(22) Filed: Feb. 11, 2005

(51) Int. Cl. B60R 7/00

(52) U.S. Cl. 224/542; 224/543

(57) ABSTRACT

A vehicle storage assembly that is selectively engagable with an interior component of a vehicle cargo area to define a storage area includes a first panel and a second panel connected to the first panel by a hinge. At least one of the first panel and the second panel has an attachment member adapted to be selectively engaged with at least one attachment location on the interior component.

### BACKGROUND OF THE INVENTION

This invention relates in general to motor vehicles and, more particularly, to a storage assembly for motor vehicle cargo areas and trunk compartments which reduces the risk that cargo will shift, slide, or roll about the cargo area and trunk compartment during the operation of the motor vehicle.

Most motor vehicles are provided with cargo areas and trunk compartments for transporting and storing cargo. Cargo areas and trunk compartments are generally defined by a horizontal load surface extending between the motor vehicle side panels and the rearmost seat and rear end of the motor vehicle. The cargo transported and stored on the load surface typically shifts, slides, or rolls about the load surface in response to the motion of the motor vehicle induced by accelerating, braking, and turning.

It is desirable to prevent cargo from shifting about the load surface in an effort to prevent cargo from spilling or from being damaged when being transported or stored. It is also often desirable to separate various cargo to prevent the various cargo from intermixing and/or damaging one another.

Of recent popularity are cargo nets. Such nets are usually formed from flexible elastic cords having hooks or other fasteners that cooperate with eyes strategically located in the motor vehicle cargo area or trunk compartment. Such nets are limited in their applications. They fail to provide a rigid structure for receiving fragile cargo. Fastening the net can require the motor vehicle operator or passenger to bend and stretch into the cargo area or trunk compartment. Moreover, deployment of the net may require tension over the cargo that can crush and damage fragile cargo.

Various organizing arrangements have been proposed for use in motor vehicle cargo areas and trunk compartments. Such arrangements include partitions or racks that divide the cargo area or trunk compartment into a plurality of discrete storage areas. Some arrangements include partitions that are collapsible to allow the arrangement to be folded and stored in a compact form. These arrangements may be expensive to manufacture, especially in the secondary market, and may be cumbersome to assemble. Moreover, such arrangements may vibrate during operation of the vehicle generating undesirable noise.

A storage apparatus is needed that permits cargo to be transported and stored in a motor vehicle without shifting or spilling that does not generate undesirable noise during vehicle operation.

### BRIEF SUMMARY OF THE INVENTION

The present invention is directed towards a motor vehicle storage assembly that meets the foregoing needs. The vehicle storage assembly is selectively engagable with an interior component of a vehicle cargo area to define a storage area and includes a first panel and a second panel connected to the first panel by a hinge. At least one of the first panel and the second panel has an attachment member adapted to be selectively engaged with at least one attachment location on the interior component.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a rear perspective view of a motor vehicle cargo area with the motor vehicle cargo hatch opened for clarity and including a storage assembly in a deployed position in the motor vehicle cargo area, in accordance with the present invention.

FIG. 2 is an enlarged cross-sectional view of a portion of the motor vehicle cargo area and storage assembly shown in FIG. 1.

FIG. 3 is an enlarged cross-sectional view of the portion of the motor vehicle cargo area and storage assembly shown in FIGS. 1 and 2 shown in a stowed position.

FIG. 4 is an enlarged cross-sectional view of the portion of the motor vehicle cargo area and storage assembly shown in FIGS. 1 through 3 shown in a shelf position.

FIG. 5 is an enlarged cross-sectional view of the portion of the motor vehicle cargo area and storage assembly shown in FIGS. 1 through 4 shown in a seating position.

FIG. 6 is an enlarged perspective view of a portion of the storage assembly shown in FIGS. 1 through 5.

FIG. 7 is an enlarged cross-sectional view of an attachment location and an attachment member for a motor vehicle cargo area and storage assembly, in accordance with the present invention.

FIG. 8 is an enlarged cross-sectional view of an attachment location and an attachment member of a second embodiment of a motor vehicle cargo area and storage assembly in accordance with the present invention.

FIG. 9 is an enlarged cross-sectional view of a portion of a third embodiment of a motor vehicle cargo area and storage assembly in accordance with the present invention.

### DETAILED DESCRIPTION OF THE PREFERRED EMBODIMENT

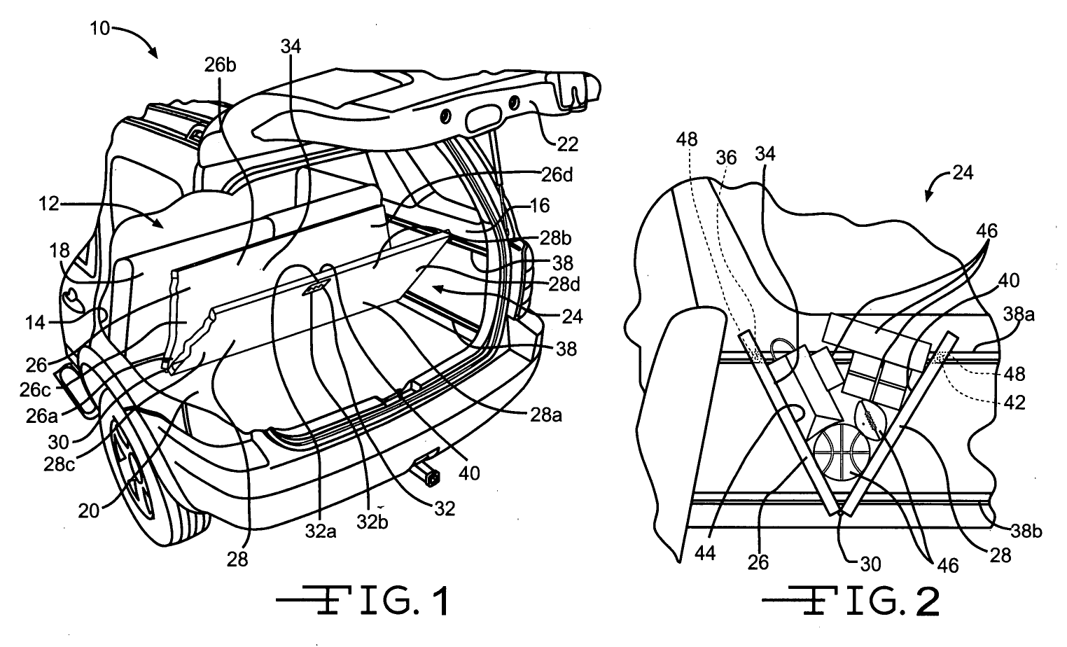

Referring now to the drawings, there is illustrated in FIG. 1 a motor vehicle 10 having a cargo area or truck compartment 12 for storing and transporting cargo. The illustrated motor vehicle 10 and cargo area 12 are, in large measure, conventional in the art and are intended merely to illustrate one environment in which this invention may be used. Thus, the scope of this invention is not intended to be limited for use with the specific structure for the motor vehicle 10 or cargo area 12 illustrated in FIG. 1 or with motor vehicle cargo areas in general. On the contrary, as will become apparent below, this invention may be used in any desired environment for the purposes described below.

The cargo area 12 is generally bounded by opposing laterally spaced walls, each comprising interior components 14, 16 and a rear seat 18 or a wall of a trunk compartment, illustrated schematically in FIG. 1. A generally horizontal floor 20 or load surface is provided for supporting cargo. A cargo hatch or trunk lid 22 is generally provided to conceal the cargo area 12, however such is illustrated in an open position in FIG. 1 for clarity purposes.

A storage assembly, indicated generally at 24, is adapted to be retained in the cargo area 12. As illustrated, the storage assembly 24 generally includes a first panel 26 and a second panel 28, although such is not required. It will be appreciated that the storage assembly 24 may have any number of panels. The first storage panel 26 is connected to the second storage panel 28 by a hinge 30. The storage assembly 24 may include a handle 32 for selectively moving and/or engaging at least one of the first panel 26 and the second panel 28 as will be described below.

In a preferred embodiment, the first panel 26 is generally rectangular, although such is not required. The first panel 26 may have a first end 26a at which the first panel 26 is connected to the hinge 30. The first panel 26 may have a second end 26b that is generally opposed from the first end 26a. The first panel 26 may also have a third end 26c and a fourth end 26d, generally opposed to one another. The first panel 26 may also have a laterally extending storage surface 34. Extending outwardly from the third end 26c and the fourth end 26d in a plane generally parallel to the storage surface 34, the first panel 26 may include attachment members 36, as best shown in FIG. 2. It will be appreciated that either or both of the third end 26c and the fourth end 26d may include attachment members 36. The attachment members 36 may selectively engage at least one attachment location 38 to secure the first panel 26 to the vehicle 10. As illustrated, the interior component 16 includes the attachment locations 38. However, it will be appreciated that either or both of the interior components 14, 16 may have attachment locations 38. Further, it will be appreciated that any portion of the cargo area 12 may include attachment locations 38 to cooperate with the storage assembly 24 as described herein.

In a preferred embodiment, the second panel 28 is also generally rectangular, although such is not required. Similar to the first panel 26, the second panel 28 may have a first end 28a at which the second panel 28 is connected to the hinge 30. The second panel 28 may have a second end 28b that is generally opposed from the first end 28a. The second panel 28 may also have a third end 28c and a fourth end 28d, generally opposed to one another. The second panel 28 may also have a laterally extending storage surface 40. Extending outwardly from the third end 28c and the fourth end 28d in a plane generally parallel to the storage surface 40, the second panel 28 may include attachment members 42, as best shown in FIG. 2. It will be appreciated that either or both of the third end 28c and the fourth end 28d may include attachment members 42. The attachment members 42 may selectively engage the at least one attachment location 38 to secure the second panel 28 to the vehicle 10.

As illustrated, the first panel 26 and the second panel 28 extend across the width of the vehicle cargo area 12. However, the first panel 26 and the second panel 28 may extend across either the length or the width of the vehicle cargo area 12 to divide the vehicle cargo area 12, or across any other portion of the cargo area 12. It will further be appreciated that the first panel 26 and the second panel 28 may cooperate with a combination of other panels (not shown) and/or other components of the cargo area 12 to divide the vehicle cargo area 12. It will also be appreciated that the first panel 26 and the second panel 28 may be generally rigid, or alternatively, either or both panel 26, 28 may include a flexible member, such as a net or fabric that may additionally have a rigid frame member.

The hinge 30 allows the first panel 26 to pivot relative to the second panel 28. The hinge 30 may include any mechanism or material capable of connecting the first panel 26 to the second panel 28 while allowing the first panel 26 and the second panel 28 to pivot relative to one another, such as a piano hinge or a flexible carpet layer. It will be appreciated that the first panel 26 and the second panel 28 may be formed integrally and the hinge 30 may be formed by a flexible portion therebetween, such that the hinge 30 is a living hinge. The hinge 30 may be formed by a notch of relatively smaller thickness of the material comprising the first panel 26 and the second panel 28. It will also be appreciated that the hinge 30 may be formed by an outer layer of flexible material, such as a carpet layer, connected to a portion of the first panel 26 and the second panel 28. It will further be appreciated that the hinge 30 may be formed by a portion of an outer layer that is adjacent to such a notch formed in, portion having a lesser amount of, or portion devoid of the material forming the first panel 26 and the second panel 28.

The handle 32 may assist a user in moving and/or positioning the storage panel assembly 24. The handle 32 may include an opening 32a through a portion of the second panel 28. The opening 32a may accommodate the hand of a user so that the user can take hold of the second panel 28 to move the second panel 28. Additionally, in a preferred embodiment of the invention, the handle 32 may also include a first release mechanism 32b. The first release mechanism 32b may engage and/or disengage the attachment members 40 of the second panel 28 from the attachment locations 38. For example, the attachment members 42 may extend from the second panel 28 while the first release mechanism 32a is not engaged. When the first release mechanism 32b is actuated by a user, the attachment members 42 may retract inward toward the second panel 28, such that the second panel 28 is free to move relative to the attachment locations 38 and the vehicle 10. The user may position the second panel 28 adjacent the desired attachment locations 38 and then release the first release mechanism 26. When the first release mechanism 26 is released, the attachment members 42 are released so that the attachment members 42 engage the portion of the attachment locations 38 adjacent the attachment members 42 to secure the second panel 28 in the selected position relative to the vehicle. It will be appreciated that the first release mechanism 32a may retract or extend all or only a portion of the attachment members 42 of the second panel 28. In a further preferred embodiment, the handle 32 may include a second release mechanism 32c. The second release mechanism 32c may engage and/or disengage the attachment members 36 of the first panel 26 from the attachment locations 38, in a manner similar to that described above for the first release mechanism 32b. In a more preferred embodiment, a user may actuate the first release mechanism 32b and the second release mechanism 32c at the same time to release both the first panel 26 and the second panel 28 so that the assembly 24 is removable from the vehicle 10. It will further be appreciated that the attachment members 36 may be actuated, removed from the attachment locations 38, and positioned and placed within the attachment locations 38 in any manner in accordance with this invention.

As illustrated in FIGS. 1 and 2, the storage surface 34 of the first panel 26, the storage surface 40 of the second panel 28, and the hinge 30 define a storage area 44. The storage area 44 may be further defined by the interior components 14, 16, although such is not required. It will be appreciated that the first panel 26 and the second panel 28 may not extend between the interior components 14, 15 and that additionally, the storage assembly 24 may include netting or other flexible end walls (not shown) extending respectively between the third end 26c of the first panel 26 and the third end 28c of the second panel 28 and/or between the fourth end 26d of the first panel 26 and the fourth end 26d of the second panel 28 to further define the storage area 44. The storage area 44 may be adapted to store a variety of articles 46, as shown in FIG. 2.

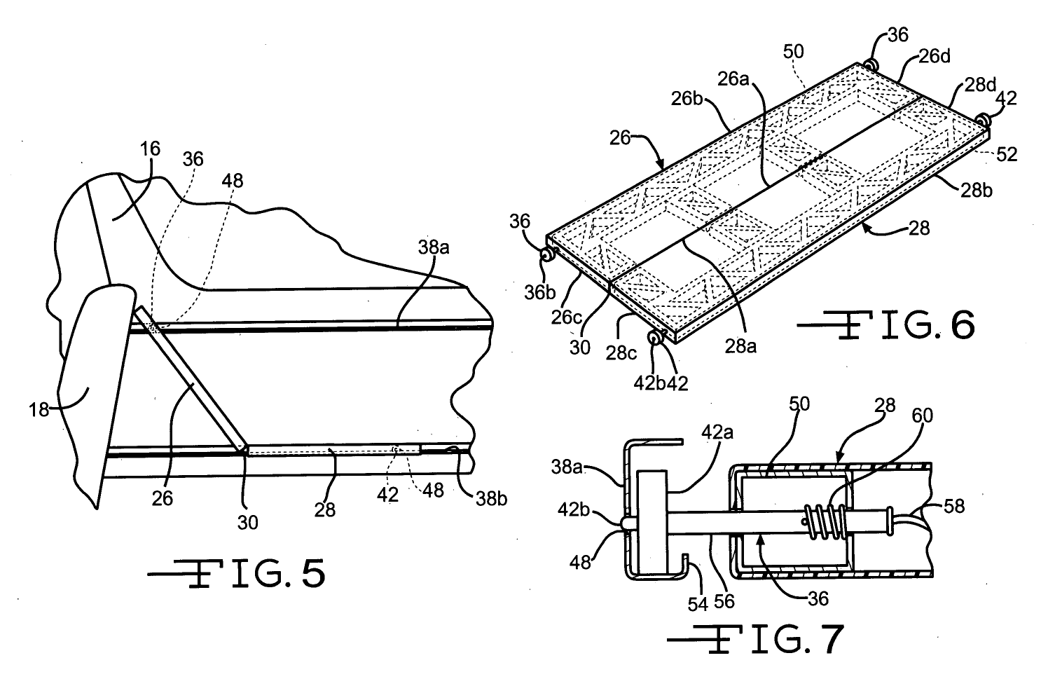

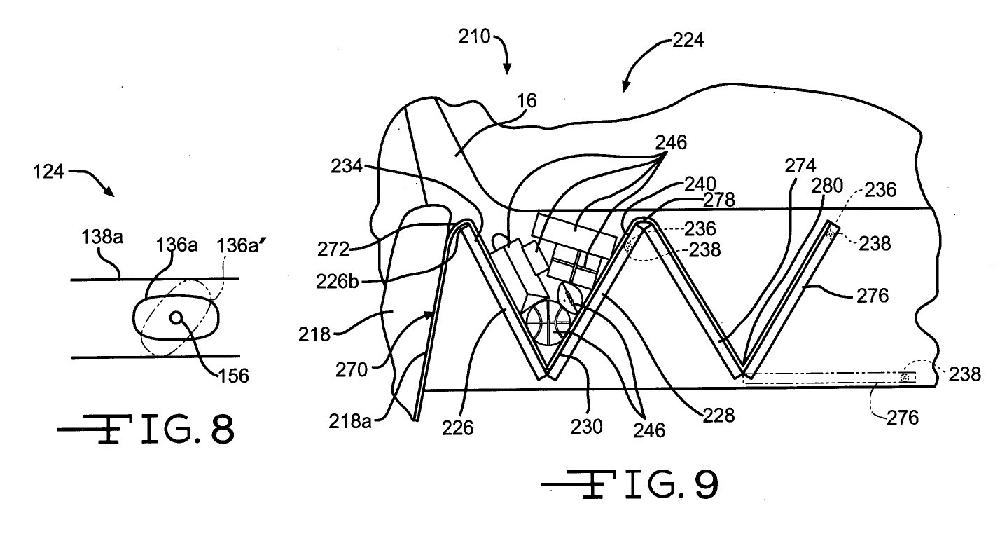

Preferably, the attachment members 36 may be provided at opposed ends 26c, 26d of the first panel 26 and the attachment members 42 may be provided at opposed ends 28c, 28d of the second panel 28, although such is not required. More preferably, the attachment members 36 are provided at opposed ends 26c, 26d near the second end 26b of the first panel 26 and the attachment members 42 are provided at opposed ends 28c, 28d near the second end 28b of the second panel 28, such that the attachment members 38 are spaced apart from the hinge 30. It will be appreciated that the attachment members 36, 42 may be provided at only one of the sides of each of the first panel 26 and the second panel 28, respectively. It will further be appreciated that the attachment members 36, 42 may extend from or be formed in the first panel 26 and the second panel 28, respectively, in any conventional manner to cooperate with the attachment locations 38. For example, the attachment members 36, 42 may be fixed or retractable pins extending from the first panel 26 and the second panel 28, respectively, to cooperate with tracks or apertures comprising the attachment locations 38, or the attachment members 36, 42 may be apertures formed in the first panel 26 and the second panel 28, respectively, that cooperate with nubs or pins comprising the attachment locations 38. As best shown in FIGS. 6 and 7, the attachment members 36, 42 each, respectively, include rollers 36a, 42a, each, respectively, having a retractable pin 36b, 42b that extends outwardly from the first panel 26 and the second panel 28, respectively, and cooperates with the attachment locations 38 to allow the first panel 26 and the second panel 28 to be removably mounted to the vehicle 10. It will further be appreciated that attachment members 36, 42 may only be provided on one of the first panel 26 and the second panel 28. In an alternate embodiment, the second panel 28 may be movably attached to the vehicle 10 by the attachment members 36 and the first panel 26 may be fixedly attached to the vehicle 10 by other means. It will be appreciated that either or both of the first panel 26 and the second panel 28 may be removably mounted within the vehicle by the attachment members 36, 42 and attachment locations 40, although it is not required that the attachment members 36, 42 and attachment locations 40 cooperate to allow either the first panel 26 or the second panel 28 to be removably mounted to the vehicle 10.

The attachment locations 38 may be provided in or on the either or both of the interior components 14, 16. However, it will be appreciated that the attachment locations 38 may alternatively, or additionally, be provided on any component defining the cargo area 12, such as, for example, the rear seat 18 or the cargo hatch 22. The attachment locations 38 may include any structure capable of cooperating with the attachment members 36 to secure one of the first panel 26 and the second panel 28 to the vehicle 10. For example, the attachment locations 38 may include track members, slots, apertures, nubs, tangs, or pins that may be selectively engaged with corresponding attachment members 36, 42. As illustrated in FIGS. 1 through 5, the attachment locations 38 include a first track member 38a and a second track member 38b on each of the interior components 14, 16. It will be appreciated that the attachment locations 38 may include any number of track members, and may alternatively not include any track members. It will further be appreciated that the track members 38a, 38b may each include at least one aperture 48 further defining the attachment locations 38, as will be described in more detail below.

As shown in FIGS. 1 and 2, the storage assembly 24 is shown in a deployed position. In the deployed position, the storage area 44 has a generally V-shaped cross-section. In the deployed position, the first panel 26 and the second panel 28 are pivoted about the hinge 30 to have an angle of less than 180° therebetween and preferably, the first panel 26 and the second panel 28 have an angle of less than 90° therebetween. The attachment member 36 and the attachment member 42 are spaced apart from one another and each is engaged with an attachment location 38 formed by the first track member 38a.

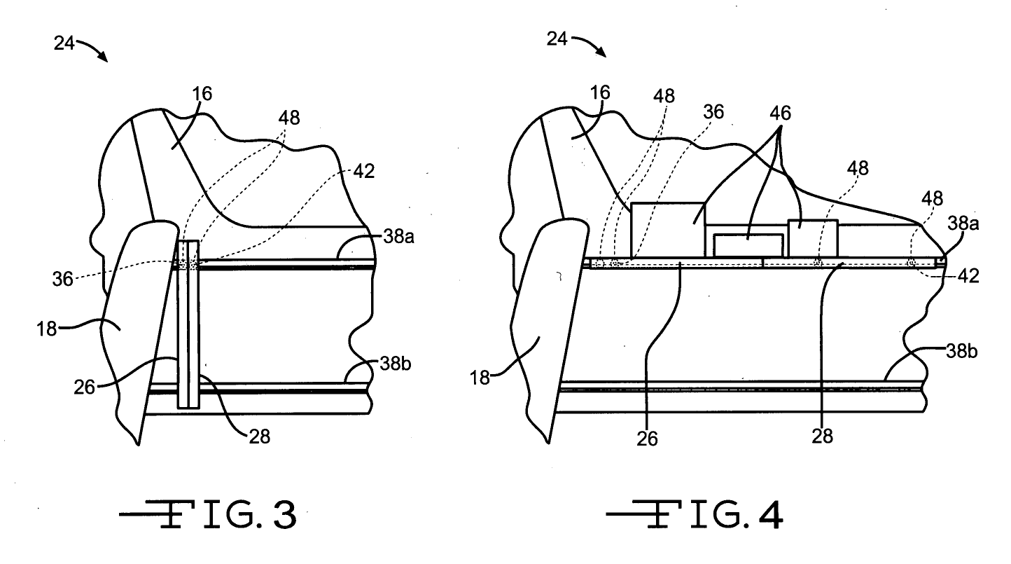

Referring now to FIG. 3, the storage assembly 24 is shown in a stowed position. In the stowed position, the storage surface 34 and the storage surface 40 are generally parallel and adjacent one another and the storage area 44 is effectively eliminated. In the stowed position, the first storage panel 26 and the second storage panel 28 may be generally adjacent to the rear seat 18 of the vehicle 10, although such is not required. The attachment member 36 and the attachment member 42 are generally adjacent one another and at least one of the attachment member 36 and the attachment member 42 is engaged with an attachment location 38 formed by the first track member 38a.

Referring now to FIG. 4, the storage assembly 24 is shown in a shelf position. In the shelf position, the storage surface 34 and the storage surface 40 are parallel to one another and generally extend in the same plane as one another. The first panel 26 and the second panel 28 have been pivoted about the hinge 30, such that the angle between the first panel 26 and the second panel 28 is generally about 180°. In the shelf position, the storage surface 34 and the storage surface 40 are spaced apart from and generally parallel to the floor 20. The attachment member 36 and the attachment member 42 are generally spaced apart from one another and each is engaged with an attachment location 38 formed by the first track member 38a.

Referring now to FIG. 5, the storage assembly 24 is shown in a seating position. In the seating position, the angle between the first panel 26 and the second panel 28 is preferably greater than 90°. The attachment member 36 of the first panel 26 engages an attachment location formed be the first track member 38a and the first panel 26 extends between the first track member 38a and the second track member 38b at an angle such that the second panel 28 extends generally parallel to the floor 20. The attachment member 42 is engaged with an attachment location 38 formed by the second track member 38b.

Referring now to FIG. 6, a preferred embodiment of the first panel 26 and the second panel 28 is illustrated. As illustrated, the first panel 26 includes an internal frame member 50 and the second panel 28 includes an internal frame member 52, although such is not required. The first panel 26 and the second panel 28 may be formed without internal frame members in accordance with the present invention. The internal frame members 50, 52 may be formed from any suitable material, such as but not limited to steel or plastic. The first panel 26 and the second panel 28 may be molded around the respective frame members 50, 52 or the first panel 26 and the second panel 28 and the respective frame members 50, 52 may be formed integrally. The first panel 26, the second panel 28, and the frame members 50, 52 may be blow molded, injection molded, or twin sheet/compression molded. It will further be appreciated that the first panel 26 and the second panel 28 may be comprised of laminates, such as a tri-laminate including a foam layer disposed between two hard layers. The frame member 50 and the frame member 52 may include a spring mechanism (not shown) that urges the frame member 50 and the frame member 52 to pivot apart from one another about the hinge 30 so that the assembly 24 is urged toward the shelf position. However, it will be appreciated that no spring mechanism is required and, alternatively, it may be desirable to include a spring mechanism that urges the frame members 50, 52 such that the assembly 24 is urged toward the stowed position.

Referring now to FIG. 7, a preferred embodiment of the attachment member 42 and the attachment location 38 is illustrated. As illustrated, that attachment location 38 is comprised of the track member 38a and the aperture 48. The track member 38a is shaped to removably receive the roller 42a of the attachment member 42. The aperture 48 is shaped to receive the pin 42b of the attachment member 42. As illustrated, the pin 42b is extended to engage the aperture 48 and lock the second panel 28 in a position relative to the vehicle 10. The track member 38a has a lip 54 that retains the roller 42a within the track member 38a. The attachment member 42 may further include a retractable shaft 56 that is communicably connected to the first release mechanism 32a of the handle 32 by a cable member 58. The roller 42a may be supported on the shaft 56. The attachment member 42 may additionally include a spring member 60 that urges the shaft 56 and roller 42a outward away from the second panel 28, although such is not required. To move the second panel 28 relative to the vehicle, the user may actuate the first release mechanism 32a of the handle 32. When the first release mechanism 32a is actuated, the cable member 58 is pulled away from the track member 38a and the shaft 56, roller 42a, and pin 42b are moved away from the track member 38a such that the pin 42b is removed from the aperture 48. The lip 54 prevents the roller 42a from further lateral movement away from the track member 38a and retains the roller 42a within the track member 38a. The roller 42a is then free to roller within the track member 38a and may be relocated adjacent another attachment location 38 formed by the track member 38a and cooperatively locked to the attachment location 38 by releasing the first release mechanism 32a as desired. To remove the roller 42a from the track member 38a, a user may actuate the first release mechanism 32a as described above and then lift the second panel 28 upward such that the roller 42a is also moved upward within the track member 38a. Once the roller 42a has been lifted to clear the lip 54 of the track member 38a, the first release mechanism 32a may be further actuated, such that the shaft 56 and roller 42a move further away from the track member 38a. The second panel 28 may then be moved so that the roller 42a is not adjacent to the track member 38a and the second panel 42 is then free to move without restraint by the track member 38a. Removing the roller 42a from the track member 38a may be desirable so that the roller 42a may be positioned within an attachment location formed by the second track member 38b, such as shown in FIG. 5.

Referring now to FIG. 8, there is illustrated a second embodiment of a portion of a storage assembly, indicated generally at 124, in accordance with the present invention. The storage assembly 124 is similar to the storage assembly 24 and generally only the components that differ will be described herein. Many of the components of the storage assembly 124 as illustrated in FIG. 8 are similar in structure and function to corresponding components of the storage assembly 24 as illustrated in FIGS. 1 through 7. Therefore, such corresponding components are indicated by similar reference number in these Figures, but with the components of the storage assembly 124 as illustrated in FIG. 8 having the addition of 100 to each reference number.

The storage assembly 124 includes an attachment location 138 formed by a track member 138a connected to the vehicle 10. The track member 138a is similar to the track member 38a with the exception that the track member 138a may not include any apertures, like the apertures 48. The storage assembly 124 includes an attachment member 136 having a cam 136a that is pivotable about a shaft 156. As illustrated, the cam 136a is generally elliptical. When the cam 136a is disposed such that the length of the cam 136a extends generally parallel to the track member 138a, the cam 136a is free to move along the track member 138a. The cam 136a is rotatable within the track member 138a, such that the length of the cam 136a is not generally parallel to the length of the track member 138a so that the length of the cam 136a frictionally engages the walls of the track member 138a as indicated by phantom lines 136a′. It will be appreciated that the attachment member 136 may frictionally engage the attachment location 138 in any manner in accordance with this invention. When the cam 136a engages the track member 138a, the cam 136a and the track member 138a cooperate to lock a storage panel (not shown) that is connected to the cam 136a in the selected position relative to the vehicle 10. The cam 136a may be pivoted to engage and disengage the track member 138a by a release mechanism (not shown) similar to the release mechanism 32a of the handle 32.

Referring now to FIG. 9, there is illustrated a third embodiment of a portion of a storage assembly, indicated generally at 224, in accordance with the present invention. The storage assembly 224 is similar to the storage assembly 24 and generally only the components that differ will be described herein. Many of the components of the storage assembly 224 as illustrated in FIG. 9 are similar in structure and function to corresponding components of the storage assembly 24 as illustrated in FIGS. 1 through 7. Therefore, such corresponding components are indicated by similar reference number in these Figures, but with the components of the storage assembly 224 as illustrated in FIG. 9 having the addition of 200 to each reference number.

The storage assembly 224 includes a flexible member 270. The flexible member 270 may be any flexible material including any textile, polymer, or fabric, such as carpet, vinyl, rubber, cloth, thermoplastic olefin (TPO), or any other flexible material or combination thereof. It will be appreciated that the flexible member 270 may be formed in any manner, such as from extruded sheets of material or by molding. It will further be appreciated that, preferably, the flexible member 270 may be comprised of a flooring material, such as UltraFloor™ available from Lear Corporation, Southfield, Mich. The flexible member 270 may extend over at least a portion of a storage surface 234 of a first panel 226 and a storage surface 240 of a second panel 228. A portion of the flexible member 270 disposed between the first panel 226 and the second panel 228 may form a hinge 230. The flexible member 270 may extend beyond the storage surface 234 to form a second hinge 272, such that the flexible member 270 pivotably mounts an end portion 226b to the cargo area 12 of the vehicle 10. As illustrated, the flexible member 270 mounts the end portion 226b to the rear seat 218 and the flexible member 270 extends across a rear surface 218a of the rear sear 218. It will be appreciated that the flexible member 270 may be formed integral to a portion of any other component of the vehicle 10, such as the rear seat 16 or the floor 20. In this embodiment, the first panel 226 is fixedly pivotably mounted to the vehicle 10 by the second hinge 272. Therefore, the assembly 224 is not removable from the vehicle 10, although such is not required. It will be appreciated that the first panel 226 may be removably mounted to the vehicle 10 as described in prior embodiments and the assembly 224 may be removable from the vehicle 10.

As illustrated, the flexible member 270 may extend beyond the second panel 228 and extend across a third panel 274 and a fourth panel 276, although such is not required. It will be appreciated that the assembly 224 may include any number of panels. Between the second panel 228 and the third panel 274, the flexible member 270 may form a third hinge 278. Between the third panel 274 and the fourth panel 276, the flexible member 270 may form a fourth hinge 280. The third panel 274 and the fourth panel 276 may be mounted within the vehicle 10 in a manner similar to that described for the first panel 226 and the second panel 228.

The second panel 226 is removably mounted to the vehicle 10 by at least one attachment member 236 that cooperates with at least one attachment location 238 formed in an interior component 16 of the vehicle 10. The attachment member 236 selectively engages the attachment member 236 to lock the second panel 226 to the vehicle 10. As illustrated, the third panel 274 does not include any attachment members and hangs between the second panel 228 and the fourth panel 276. The fourth panel 276 includes attachment members 236 that cooperate with attachment locations 238 as described for the second panel 228. It will be appreciated that any combination of the first panel 226, the second panel 228, the third panel 274 and the fourth panel 276 may include at least one attachment member 236 in accordance with the present invention. As illustrated, three attachment locations 238 are provided. However, it will be appreciated that any number of attachment locations 238 may be provided, including a single attachment location 238. As illustrated, the fourth panel 276 is movable from the deployed position, as shown in FIG. 9, to a seating position, as indicated by phantom lines 276′. As illustrated, each of the attachment locations 238 is comprised of an aperture formed in the interior component 16, although such is not required.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle storage assembly selectively engagable with an interior component of a vehicle cargo area to define a storage area, said vehicle storage assembly comprising:
a first panel; and
a second panel connected to said first panel by a hinge,
at least one of said first panel and said second panel having an attachment member adapted to be selectively engaged with at least one attachment location on the interior component.

2. The vehicle storage assembly according to claim 1, wherein said first panel, said second panel, and said hinge are integrally formed.

3. The vehicle storage assembly according to claim 1, wherein said first panel has an attachment member adapted to be selectively engaged with a plurality of attachment locations on the interior component and said second panel has an attachment member adapted to be selectively engaged with a plurality of attachment locations on the interior component.

4. The vehicle storage assembly according to claim 1, wherein said first panel has a first attachment member and a second attachment member extending outwardly, respectively, from opposed ends of said first panel.

5. The vehicle storage assembly according to claim 4, wherein said first panel extends generally between a first interior component and a second interior component such that said first attachment member is adapted to selectively engage with at least one attachment location on said first interior component and said second attachment member is adapted to selectively engage with at least one attachment location on said second interior component.

6. The vehicle storage assembly according to claim 1, wherein said first panel is hingedly attached to an interior component of the vehicle cargo area.

7. The vehicle storage assembly according to claim 1, wherein said first panel and said second panel are adapted to be removably mounted within said vehicle cargo area.

8. The vehicle storage assembly according to claim 1, wherein said storage assembly is movable to a deployed position in which said first storage panel and said second panel define a storage area that has a generally V-shaped cross-section.

9. The vehicle storage assembly according to claim 8, whereinsaid storage assembly is movable to a stowed position in which a laterally extending surface of said first panel and a laterally extending surface of said second panel are disposed adjacent one another.

10. The vehicle storage assembly according to claim 9, wherein said storage assembly is disposed adjacent a rear seat defining said vehicle cargo area when said storage assembly is in said stowed position.

11. The vehicle storage assembly according to claim 8, wherein said storage assembly is further positionable to a shelf position in which said first panel and said second are generally parallel to one another and are spaced apart from and generally parallel to a load surface defining said vehicle cargo area.

12. The vehicle storage assembly according to claim 8, wherein said storage assembly is further positionable to a seating position in which said first panel and said second panel extend outwardly from an axis of said hinge with an angle of at least 90° therebetween and said second panel is generally parallel to a load surface defining said cargo area.

13. The vehicle storage assembly according to claim 1, wherein said storage assembly extends across one of the length and the width of the vehicle cargo area to divide the vehicle cargo area.

14. The vehicle storage assembly according to claim 1, wherein at least a portion of at least one of said first panel and said second panel is comprised of a flexible member.

15. The vehicle storage assembly according to claim 1, wherein at least one of said first panel and said second panel is rigid.

16. The vehicle storage assembly according to claim 1, wherein said hinge is a mechanical hinge attached to said first panel and said second panel, such that said first panel and said second panel are pivotable relative to one another about said hinge.
